(19) United States
(12) Patent Application Publication
(10) Pub. No.: US 2023/0183871 A1
(43) Pub. Date: Jun. 15, 2023

(54) Zero-Gap Reactor for Carbon Dioxide Conversion Including Metal Nanoclusters, and Carbon Dioxide Conversion Method Using the Same

(71) Applicant: Industry-Academic Cooperation Foundation, Yonsei University, Seoul (KR)

(72) Inventors: Dongil Lee, Goyang-si (KR); Hoeun Seong, Seoul (KR)

(21) Appl. No.: 17/990,191

(22) Filed: Nov. 18, 2022

(30) Foreign Application Priority Data
Nov. 19, 2021 (KR) 10-2021-0160632
Apr. 19, 2022 (KR) 10-2022-0048109

(51) Int. Cl. C25B 11/085; B01D 53/32; C25B 1/23; C25B 11/081

(52) U.S. Cl. CPC C25B 11/085; B01D 53/326; C25B 1/23; C25B 11/081

(57) ABSTRACT

Provided are a carbon dioxide conversion method exhibiting excellent conversion rate and selectivity using a zero-gap reactor including metal nanoclusters, and a system capable of exhibiting excellent conversion performance even in a flue gas having a low concentration of carbon dioxide.

### CROSS-REFERENCE TO RELATED APPLICATIONS

This application claims priority to Korean Patent Application No. 10-2021-0160632 filed Nov. 19, 2021, and Korean Patent Application No. 10-2022-0048109 filed Apr. 19, 2022, the disclosures of which are hereby incorporated by reference in their entireties.

### BACKGROUND OF THE INVENTION

### Field of the Invention

The following disclosure relates to a zero-gap reactor for carbon dioxide conversion including metal nanoclusters and a carbon dioxide conversion method using the same.

### Description of Related Art

Nanoclusters or superatoms composed of a specific number of metal atoms and ligands follow a superatomic orbital theory which states that a valence electron of a particle is newly defined as a single superatom.

Nanoclusters are more stable than a single atom or nanoparticles, and have stronger molecular properties than metallic properties, and thus have completely different optical and electrochemical properties from nanoparticles. In particular, as optical, electrical, and catalytic properties of nanoclusters vary sensitively depending on the number of metal atoms, types of metal atoms, and ligands, research on the nanoclusters has been actively conducted in a wide variety of fields.

Meanwhile, after the Industrial Revolution, population growth and industrialization increase the use of fossil fuels, which leads to an increase in greenhouse gas emissions and an increase in a concentration of greenhouse gases in the atmosphere, resulting in global warming, in which the earth's average temperature rises. As a result, efforts have been conducted to reduce carbon dioxide emissions through the 2015 Paris Agreement on Climate Change.

A carbon dioxide conversion technology through electrochemical reduction is a technology that reduces carbon dioxide to a useful carbon compound through the movement of electrons by generating a potential difference between electrodes by inputting electrical energy. Also advantages of the carbon dioxide conversion technology are that a reduction reaction of carbon dioxide may be performed even at room temperature and pressure, and water and carbon dioxide are the only raw materials required for a reaction, and thus an electrolyte is recycled so that chemicals are not emitted, and a process is simple.

Such an electrochemical reduction technology is greatly affected by the type of electrode catalyst, the nature of the electrolyte, and the reaction conditions such as pH, temperature, and pressure. Thus, in order to reduce carbon dioxide and convert it into a useful carbon compound, in particular, research on the type of electrode catalyst and the electrolyte used has been required, and the development of a catalyst that inhibits a hydrogen generation reaction, which is a competing reaction, and has excellent selectivity for the reduction reaction of carbon dioxide, has been continuously demanded.

As the reactor used in the carbon dioxide electrochemical reduction technology so far, a flow-through electrolytic cell having a gap structure in which an electrode and a separator are separated by several mm intervals has been used. Recently, however, research has been conducted to use a zero-gap reactor with a sandwich-type zero-gap structure in which a cathode and an anode having a separator therebetween are in contact with each other that reduces solution ion resistance due to the presence of the electrolyte in the gap between the electrode and the separator, and eliminates the gap between the electrode and the separator in order to reduce an increase in mass transfer resistance due to a product gas when implementing a large-area electrode.

In addition, existing research on carbon dioxide conversion have focused on converting concentrated carbon dioxide at 100% partial pressure. However, a process of separating and concentrating carbon dioxide in a flue gas from factories and power plants is extremely complex and involves a lot of cost. Therefore, research has been conducted to directly convert low-concentration carbon dioxide without such separate separation and concentration processes.

### RELATED ART DOCUMENT

### Patent Document

(Patent Document) Korean Patent Registration No. KR 10-2372659 B1
(Patent Document 2) U.S. Pat. No. 9,370,773 B2

### SUMMARY OF THE INVENTION

An embodiment of the present invention is directed to providing a carbon dioxide conversion method exhibiting excellent conversion rate and selectivity using a zero-gap reactor including metal nanoclusters, and a system capable of exhibiting excellent conversion performance even with a flue gas having a low concentration of carbon dioxide.

In one general aspect, there is provided a zero-gap reactor for carbon dioxide conversion including an anode; a cathode including a metal nanocluster catalyst; and a separator positioned between the cathode and the anode, wherein the cathode and the anode of the zero-gap reactor may be positioned in contact with one surface of the separator, respectively.

The zero-gap reactor may further include a cathode support in contact with one surface of the cathode, provided that the one surface of the cathode support may further include a carbon dioxide inlet and a carbon monoxide outlet, and may further include an anode support in contact with one surface of the anode, provided that the anode support may further include a hydroxy group-containing reactant inlet and an oxygen outlet.

The cathode support or the anode support may further include a flow path connecting each inlet and outlet.

The cathode of the zero-gap reactor may be a gas diffusion electrode including metal nanoclusters, and the gas diffusion electrode may include a porous support and a metal nanocluster catalyst fixed to the pores of the porous support.

Specifically, the porous support may be a porous carbon body, the porous support may have an average pore size of 10 to 1000 nm, the metal nanocluster catalyst may have an average particle size of 1 to 5 nm, and the metal nanocluster catalyst may be supported at a density of 1 to 100 nmol/cm² per unit area of the porous support.

The metal nanocluster catalyst used in the cathode of the zero-gap reactor may be represented by the following Formula 1:

[Formula 1]

Mₙ(SR)ₘ

wherein M is Au or Ag;

SR is C1-C20 alkylthiol, C3-C20 alkenylthiol, C3-C20 alkynylthiol, C6-C20 allylthiol, C3-C20 cycloalkylthiol, C5-C20 heteroallylthiol, C3-C20 heterocycloalkylthiol, or C6-C20 arylC1-C20 alkylthiol;

n is 25, 38, or 144; and

m is 18, 24, or 60.

Specifically, SR in Formula 1 may be C1-C10 alkylthiol, C3-C10 alkenylthiol, C3-C10 alkynylthiol, C6-C12 allylthiol, C3-C10 cycloalkylthiol, C5-C12 heteroallylthiol, C3-C10 heterocycloalkylthiol, or C6-C10 arylC1-C10 alkylthiol.

The anode in the zero-gap reactor may be one or two or more alloys selected from nickel (Ni), iron (Fe), and iridium oxide (IrO₂), and the separator may be an ion exchange membrane.

In another general aspect, there is provided a carbon dioxide conversion method, and specifically, the method including: supplying a carbon dioxide-containing reaction gas to one surface of a cathode of a zero-gap reactor for carbon dioxide conversion; and obtaining a carbon monoxide-containing product gas converted from carbon dioxide from one surface of the cathode, wherein the zero-gap reactor for carbon dioxide conversion is the zero-gap reactor for carbon dioxide conversion as described above.

The reaction gas may further include one or more selected from nitrogen, oxygen, moisture, NOₓ, SOₓ, and particulate matter, and may be an exhaust gas of a process of discharging carbon dioxide.

### BRIEF DESCRIPTION OF THE DRAWINGS

FIG. 1 is a schematic diagram illustrating a zero-gap reactor.

FIG. 2 is a schematic diagram illustrating a flow-through electrolytic cell.

FIG. 3 is a diagram illustrating a gas diffusion electrode including metal nanoclusters and a zero-gap reactor for carbon dioxide conversion using the same.

FIG. 4 is a diagram illustrating a result of measuring a conversion rate of carbon dioxide and a selectivity for a carbon dioxide conversion reaction of Examples 1 and 3.

FIG. 5 is a diagram illustrating a result of measuring the cell resistance values of Examples 1 and 3.

FIG. 6 is a diagram illustrating a result of measuring stability during long-term operation at a constant current density in Example 1.

FIG. 7 is a diagram illustrating a result of measuring a conversion rate of carbon dioxide of Example 2.

FIG. 8 is a diagram illustrating a result of measuring a selectivity for a carbon dioxide conversion reaction of Example 2.

FIG. 9 is a diagram illustrating a result of measuring conversion rates of carbon dioxide of Examples 3 to 5 and Comparative Example 1.

FIG. 10 is a diagram illustrating a result of measuring the conversion rate of carbon dioxide of Example 1.

FIG. 11 is a diagram illustrating a result of measuring the selectivity for a carbon dioxide conversion reaction of Example 1.

### DESCRIPTION OF THE INVENTION

Hereinafter, a zero-gap reactor for carbon dioxide conversion including the metal nanoclusters according to the present invention, and a carbon dioxide conversion method using the same will be described in detail.

Singular forms used herein are intended to include the plural forms as well unless otherwise indicated in context.

In addition, numerical ranges used herein include a lower limit, an upper limit, and all values within that range, increments that are logically derived from the type and width of the defined range, all double-defined values, and all possible combinations of upper and lower limits of numerical ranges defined in different forms. Unless otherwise defined herein, values outside the numerical range that may arise due to experimental errors or rounded values are also included in the defined numerical range.

As used herein, the term “comprise” is an “open” description having the meaning equivalent to expressions such as “include”, “contain”, “have”, or “feature”, and does not exclude elements, materials, or process that are not further listed.

Hereinafter, the present invention will be described in detail. Technical terms and scientific terms used herein have the general meaning understood by those skilled in the art to which the present invention pertains, unless otherwise defined, and a description for the known function and configuration unnecessarily obscuring the gist of the present invention will be omitted in the following description.

In order to respond to climate change due to carbon emissions, interest in electrochemical carbon dioxide conversion is high, and among these electrochemical carbon dioxide conversions, since carbon monoxide has a high market price, research on the conversion reaction of carbon dioxide to carbon monoxide has been actively conducted.

The carbon dioxide conversion technology through electrochemical reduction proceeds as in the following Scheme 1, and the reduction reaction of carbon dioxide is conducted in an aqueous electrolyte. Since the reduction potential regions of hydrogen and carbon dioxide generated from the aqueous solution are similar, the reduction reaction of carbon dioxide and hydrogen generation may occur simultaneously, and thus selectivity thereof may be very important.

[Scheme 1]

CO₂+e⁻+H₂O→COOH*+OH⁻120 mVdec⁻¹

COOH*+e⁻→CO*+OH⁻40 mVdec⁻¹

co*→co 30 mVdec⁻¹

In order to solve the above problems, the carbon dioxide conversion technology with excellent selectivity in the reduction reaction of carbon dioxide and a technology that exhibits an excellent carbon dioxide conversion rate are required. Therefore, as a result of intensifying research on this, the inventors of the present invention have completed the present invention by finding that the zero-gap reactor exhibits an excellent conversion rate of carbon dioxide and significantly improved selectivity for the carbon dioxide conversion reaction by introducing a zero-gap reactor that may replace the conventional flow-through electrolytic cell with high resistance due to an interpolar distance and an electrolyte in a carbon dioxide conversion system and at the same time including a metal nanocluster catalyst at the cathode of the reactor.

The present invention provides a zero-gap reactor for carbon dioxide conversion including an anode; a cathode including a metal nanocluster catalyst; and a separator positioned between the cathode and the anode.

The zero-gap reactor including the metal nanoclusters according to the present invention exhibits an excellent performance compared to the conversion of carbon dioxide using a conventional flow-through electrolytic cell, and is a system with significantly improved selectivity for the conversion reaction of carbon dioxide.

A cathode and an anode of the zero-gap reactor may be positioned in contact with one surface of the separator, respectively. Specifically, the separator may be positioned in contact with a microporous layer (MPL) of a gas diffusion electrode including metal nanoclusters as a cathode. Specifically, the zero-gap reactor may be manufactured by positioning and compressing a separator between the cathode and the anode.

The zero-gap reactor according to an exemplary embodiment of the present invention may further include a cathode support in contact with one surface of the cathode, provided that the one surface of the cathode support may further include a carbon dioxide inlet and a carbon monoxide outlet, and may further include an anode support in contact with one surface of the anode, provided that the anode support may further include a hydroxy group-containing reactant inlet and an oxygen outlet, wherein the cathode support or the anode support may further include a flow path connecting each inlet and outlet.

Specifically, the anode support according to an exemplary embodiment is made of titanium and includes a tortuous flow path, and the flow path may be connected to a hydroxyl-containing reactant inlet and an oxygen outlet. In addition, the cathode support is made of stainless steel and includes a tortuous flow path, and the flow path may be connected to a carbon dioxide inlet and a carbon monoxide outlet. The reactant inlet and outlet connected to the anode support may be connected to a pump circulating the reactant.

Specifically, the carbon dioxide inlet of the cathode support may be connected to a gaseous carbon dioxide source and a humidifier for humidifying gaseous carbon dioxide. As the humidifier, a temperature-controlled bubble generating type humidifier may be used, but the present invention is not limited thereto. Also, the carbon monoxide outlet of the cathode support may be connected to a water separator for removing moisture from gaseous products, and the reactant inlet of the anode support may be connected to an electrolyte replenishment unit including an electrolyte.

The cathode of the zero-gap reactor according to an exemplary embodiment of the present invention may be a gas diffusion electrode including metal nanoclusters, and the gas diffusion electrode may include a porous support and a metal nanocluster catalyst fixed to the pores of the porous support.

The porous support is a microporous layer (MPL) and may be used without limitation as long as it is a porous support having conductivity, and may be specifically a carbon body. A specific example of the carbon body may be one or two or more selected from carbon black, carbon nanotube, graphene, carbon nanofiber, and graphitized carbon black, and more specifically, may be carbon black, but the present invention is not limited thereto.

In addition, the porous support may have an average pore size of 10 to 1000 nm, specifically 10 to 500 nm, and more specifically 10 to 100 nm, but the present invention is not limited thereto.

In an exemplary embodiment of the present invention, the silver nanoclusters used in the gas diffusion electrode for carbon dioxide conversion may have an average particle size of 1 to 5 nm, specifically 1 to 3 nm, and more specifically 1 to 2 nm.

The silver nanocluster catalyst may be supported at a density of 1 to 100 nmol/cm², preferably 1 to 50 nmol/cm², and more preferably 1 to 30 nmol/cm² per unit area of the porous support.

A method of supporting metal nanoclusters on a porous support according to an exemplary embodiment may include preparing and dropping a solution in which the metal nanoclusters are dispersed on the porous support, drying the solution, and then performing heat treatment. According to the above method, the dispersion of metal nanoclusters may be easily applied to the entire area of the support according to the capillary phenomenon by simply dropping the metal nanocluster dispersion on the porous support, and may be uniformly coated and stably supported. In this case, the solvent used may be any organic solvent that may be recognized by those skilled in the art. Examples of the solvent may specifically be one or two or more selected from ethanol, methanol, isopropanol, butanol, pentanol, hexanol, dichloromethane, hexane, acetone, ethylene glycol, diethylene glycol, glycerol, and propylene glycol, and the present invention is limited thereto.

As the metal nanoclusters are included as a catalyst compound of the cathode, they may be dispersed and adsorbed at a molecular level in pores of the porous support compared to conventional metal nanoparticle catalysts. Therefore, the conventional catalyst is deposited only on an upper layer of the porous support of the gas diffusion electrode, whereas the metal nanoclusters may be uniformly distributed throughout the electrode, thereby exhibiting significantly improved activity compared to the conventional catalyst. Therefore, the gas diffusion electrode including the metal nanoclusters may have significant electrochemical carbon dioxide conversion properties compared to the cathode including the metal nanoparticle catalyst.

The metal nanocluster catalyst used in the cathode of the zero-gap reactor according to an exemplary embodiment of the present invention may be represented by the following Formula 1:

[Formula 1]

Mₙ(SR)ₘ

wherein M is Au or Ag;

SR is C1-C20 alkylthiol, C3-C20 alkenylthiol, C3-C20 alkynylthiol, C6-C20 allylthiol, C3-C20 cycloalkylthiol, C5-C20 heteroallylthiol, C3-C20 heterocycloalkylthiol, or C6-C20 arylC1-C20 alkylthiol;

n is 25, 38 or 144; and

m is 18, 24, or 60.

The metal nanoclusters according to the present invention have a structure composed of a specific number of atoms and ligands, and are very useful as catalysts for carbon dioxide conversion because of their excellent activity for the conversion reaction of carbon dioxide, as well as excellent stability and uniformity.

Specifically, SR in Formula 1 may be C1-C10 alkylthiol, C3-C10 alkenylthiol, C3-C10 alkynylthiol, C6-C12 allylthiol, C3-C10 cycloalkylthiol, C5-C12 heteroallylthiol, C3-C10 heterocycloalkylthiol, or C6-C10 arylC1-C10 alkylthiol, more specifically, C1-C7 alkylthiol, C3-C7 alkenylthiol, C3-C7 alkynylthiol, C6-C10 allylthiol, C3-C7 cycloalkylthiol, C5-C10 heteroallylthiol, C3-C7 heterocycloalkylthiol, or C6-C10 arylC1-C7 alkylthiol, and preferably C1-C7 alkylthiol, but the present invention is not limited thereto.

In the SR, one or more hydrogens in a functional group may be further substituted with a substituent, wherein the substituent may be C1-C10 alkyl, halogen (—F, —Br, —Cl, —I), nitro, cyano, hydroxy, amino, C6-C20 aryl, C2-C7 alkenyl, C3-C20 cycloalkyl, C3-C20 heterocycloalkyl, or C5-C20 heteroaryl.

The metal nanocluster catalyst for carbon dioxide conversion may be prepared according to the following preparation method. A preparation method according to an exemplary embodiment may include: preparing a reaction solution by reacting a metal precursor and a catalyst; adding an organic thiol-based ligand compound to the reaction solution; and preparing metal nanoclusters represented by Formula 1 by adding a reducing agent.

A stabilized catalyst having excellent uniformity as well as very excellent activity for a carbon dioxide conversion reaction may be prepared by preparing a metal nanocluster catalyst for carbon dioxide conversion that satisfies Formula 1 through such a preparation method.

A method for preparing a catalyst according to an exemplary embodiment may effectively synthesize metal nanoclusters in which a specific number of gold or silver atoms, and organic thiol-based ligands are bonded by controlling the molarity of a metal precursor and the molarity of a reducing agent added, and using a specific solvent, thereby providing metal nanoclusters for carbon dioxide conversion having the above effects.

In the above preparation method, the preparing of the reaction solution by reacting a metal precursor and a catalyst may be performed for 1 to 60 minutes, and specifically 10 to 30 minutes. The adding of the organic thiol-based ligand compound to the reaction solution may be performed for 20 to 180 minutes, and specifically 30 to 120 minutes. The preparing of the metal nanoclusters represented by Formula 1 by adding a reducing agent may be performed for 1 to 10 hours, and specifically 3 to 7 hours.

In addition, a molar ratio of the metal precursor: the organothiol-based ligand may be 1:1 to 10, preferably 1:2 to 8, and more preferably 1:3 to 7. When the synthesis is performed within the above range, a synthesis yield is excellent and reaction impurities may be reduced, which is preferable.

The gold precursor may be any one or two or more selected from AuS(CH₃)₂Cl, AuPPh₃Cl, AuCl₃, HAuCl₄·3H₂O, KAuCl₄, and Au(OH)₂, and the silver precursor may be any one or two or more selected from AgNO₃, AgBF₄, AgCF₃SO₃, AgClO₄, AgO₂CCH₃, and AgPF₆, but the present invention is not limited thereto.

In an exemplary embodiment, the preparation method may further include a solvent, and the solvent may be used without particular limitation as long as it is commonly used in the art. A specific example of the solvent may be one or a mixture of two or more selected from C1-05 alcohol, acetonitrile, dimethyl sulfoxide, dimethylformamide, acetone, tetrahydrofuran, and 1,4-adioxane, preferably tetrahydrofuran, but the present invention is not limited thereto. In addition, the solvent may be added in amount of 10 to 100 mL, and specifically 20 to 80 mL based on 1 mmol of the gold precursor, but the present invention is not limited thereto.

The catalyst used in the preparation method of the gold nanocluster catalyst may be used without particular limitation as long as it is commonly used in the art. Specifically, the use of any one or two or more selected from tetraoctylammonium bromide and tetraphenylphosphine bromide, and more specifically, tetraoctylammonium bromide may be preferable in improving the efficiency of the reaction.

In addition, the reducing agent used in the preparation method is not particularly limited as long as it is commonly used in the art, but may be one or two or more selected from triethylamine, oleylamine, carbon monoxide, and sodium borohydride, and specifically sodium borohydride. However, the present invention is not limited thereto.

The reducing agent may be added in an amount of 5 to 30 mmol, specifically 6 to 25 mmol, and more specifically, 7 to 20 mmol, based on 1 mmol of the gold precursor, but the present invention is not limited thereto.

As described above, the cathode reduces carbon dioxide to carbon monoxide with high selectivity and high conversion rate. More particularly, the zero-gap reactor according to the present invention is the same as the schematic diagram illustrated in FIG. 1, and carbon dioxide supplied to the cathode is converted to carbon monoxide and released. An electrolyte of the zero-gap reactor may be KCl, NaOH, or KOH aqueous solution, and specifically, the electrolyte may have a pH of 7 to 14, and more specifically, a pH of 8 to 14. The concentration of the aqueous solution may be 0.1 to 10 M, specifically 0.5 to 5 M, and more specifically 0.5 to 3 M, but the present invention is not limited thereto.

The anode of the zero-gap reactor according to an embodiment may be one or two or more alloys selected from nickel (Ni), iron (Fe), and iridium oxide (IrO₂), and more specifically, the anode may be a conductive metal foam, for example, a porous nickel foam (Ni foam), but the present invention is not limited thereto.

The separator according to the present invention needs to have durability in a strong base environment, and a material having low gas permeability and high ion conductivity may be used. In an exemplary embodiment, the separator may be an ion exchange membrane. Such an ion exchange membrane may be made of ion exchange resins and ionomers known in the art, or may be purchased and used as films. For example, a Nafion™ series membrane, perfluorinated sulfonic acid group-containing polymer from DuPont, USA, may be used, and in a similar form, an Aquibion PFSA membrane from Solvey, which is a commercial membrane, a FumaSep ion exchange membrane, including cation and anion exchange membranes from Fumatek, an anion exchange membrane from Dioxide Materials, an anion exchange membrane between Orion polymers, an Aciplex-S membrane from Asahi Chemicals, a Dow membrane from Dow Chemicals, a Flemion membrane from Asahi Glass, a GoreSelect membrane from Gore & Associates, etc. may be used, but are not limited thereto.

There is provided a carbon dioxide conversion method, the method specifically including: supplying a carbon dioxide-containing reaction gas to one surface of a cathode of a zero-gap reactor for carbon dioxide conversion; and obtaining a carbon monoxide-containing product gas converted from carbon dioxide from one surface of the cathode, wherein the zero-gap reactor for carbon dioxide conversion is the zero-gap reactor for carbon dioxide conversion according to an embodiment of the present invention.

The reaction gas may further include one or more selected from nitrogen, oxygen, moisture, NOₓ, SOₓ, and particulate matter, and may be an exhaust gas of a process of discharging carbon dioxide.

The method for carbon dioxide conversion according to an exemplary embodiment uses a zero-gap reactor and a gas diffusion electrode for carbon dioxide conversion having high activity in carbon dioxide conversion reaction, whereby carbon monoxide may be reduced and carbon monoxide may be generated at an excellent conversion rate, and a very high selectivity for the reduction reaction to carbon monoxide may be exhibited compared to a hydrogen generation reaction.

Therefore, the gas diffusion electrode for carbon dioxide conversion according to the present invention may effectively convert carbon dioxide, which affects the greenhouse effect, into carbon monoxide, as a useful gas. The zero-gap reactor according to an exemplary embodiment may exhibit excellent conversion performance in a wide range of carbon dioxide concentrations ranging from low concentration to high concentration, which means that it may exhibit excellent conversion performance even in exhaust gas of general factories, including 12% of carbon dioxide on average.

Hereinafter, a zero-gap reactor for carbon dioxide conversion including metal nanoclusters according to the present invention and a carbon dioxide conversion method using the same will be described in more detail through specific examples.

The following Examples are only a reference for describing the present invention in detail, and the present invention is not limited thereto and may be implemented in various forms. Also, the terms used in the description of the present invention are only for effectively describing specific embodiments, and are not intended to limit the present invention.

### [Preparation Example 1] Preparation of Au₂₅(SC₆H₁₃)₈

After dissolving 0.5 mmol of HAuCl₄·3H₂O and 0.58 mmol of tetraoctylammonium bromide in 15 mL of tetrahydrofuran, 2.5 mmol of n-hexanethiol (C₆H₁₃SH) was added dropwise. After stirring for 60 minutes, 5 mmol of NaBH₄ (in 5 mL H₂O) was added. After stirring for 5 hours, AU₂₅(SC₆H₁₃) 18 was synthesized. When the reaction is complete, the mixture was washed 5 times with water and methanol to remove impurities, and then further washed with ethanol. The resulting mixture was extracted with a mixed solvent of acetonitrile:acetone (volume ratio=1:1) and dried to obtain high purity Au₂₅(SC₆H₁₃)₁₈.

### [Preparation Example 2] Preparation of Au₃₈(SC₆H₁₃)₂₄

After dissolving 2 mmol of glutathione in 16 mL of water, 0.5 mmol of HAuCl₄·3H₂O (in 20 mL CH₃OH) was added. After stirring for 20 minutes, the solution was cooled with an ice bath. 5 mmol of NaBH₄ (in 10 mL H₂O) was added to the solution and further stirred for 30 minutes. The solution was dried under negative pressure and then washed 10 times with methanol. The resulting mixture was dissolved in 6 mL of water, and then 16 mmol of n-hexanethiol, 0.3 mL of ethanol, and 2 mL of toluene were added. The solution was heated to 80° C. and stirred for 45 hours under reflux conditions. After stirring at room temperature for 3 hours, only the organic layer was separated and the washing was performed 10 times with ethanol and acetonitrile. Small-sized nanoclusters were extracted with a mixed solvent of acetonitrile:dichloromethane (volume ratio=2:1 and 10:5.5), and finally extracted with a mixed solvent of acetonitrile:dichloromethane (volume ratio=5:3) and dried to obtain high-purity Au₃₈(SC₆H₁₃)₂₄.

### [Preparation Example 3] Preparation of Au₁₄₄(SC₆H₁₃)₆₀

After dissolving 0.6 mmol of HAuCl₄·3H₂O and 0.7 mmol of tetraoctylammonium bromide in 30 mL of methanol, 2.5 mmol of n-hexanethiol (C₆H₁₃SH) was added dropwise for 3 minutes. After stirring for 60 minutes, 6 mmol of NaBH₄ (in 12 mL H₂O) was added. After stirring for 5 hours, Au₁₄₄(SC₆H₁₃)₆₀ was synthesized. When the reaction is complete, the mixture was washed 5 times with water and methanol to remove impurities, and then further washed with ethanol and acetone. Nanoclusters were extracted with a mixed solvent of acetonitrile:dichloromethane (volume ratio=10:8) to remove impurities, and then extracted with a mixed solvent of acetonitrile:dichloromethane (volume ratio=10:13) and dried to obtain high-purity Au₁₄₄(SC₆H₁₃)₆₀.

### [Preparation Example 4] Preparation of [Ag₂₅(SPhMe₂)_{18]}¹⁻

40.0 mg of AgNO₃ (0.23 mmol) was dissolved in 2 mL of methanol, and then 15 mL of tetrahydrofuran (THF) was added and stirred. 0.090 mL of 2,4-dimethylbenzenethiol (0.65 mmol) was added to the reaction solution and stirred for 20 minutes under an ice bath. To the reaction solution, 6 mg of tetraphosphonium bromide (0.014 mmol) dissolved in 1 mL of methanol was added, and 15 mg of NaBH₄ (0.4 mmol) dissolved in 0.5 mL of ice-cold water was added. The mixture was subjected to a reduction reaction by stirring for 3 hours, aged for 12 hours, and then centrifuged to obtain a precipitate, and washed with methylene chloride and methanol, respectively, to remove impurities. 3 mg of the obtained product was dissolved in 0.5 mL of methylene chloride, and then recrystallized by adding 5 mL of n-hexane to obtain [Ag₂₅(SPhMe₂)₁₈]¹⁻.

### Example 1

A solution of 30 μg of the nanoclusters of Preparation Example 1 dissolved in 160 μL of dichloromethane and 160 μL of acetone were mixed, and ultrasonic dispersion was performed for about 1 minute to prepare a nanocluster composite dispersion. Next, the prepared nanocluster composite dispersion was subjected to solution deposition on a gas diffusion microporous carbon electrode (GDE (W1S1011, Ce-Tech)) with an area of 2.5×2.5 cm² to manufacture a nanocluster composite gas diffusion electrode, and the average loading amount of the nanocluster was measured to be 0.63 nmol/cm².

The manufactured gas diffusion electrode was used as a cathode, Ni foam (NiF, 29-04275-01, Invisible Inc.) with an area of 3×3 cm² area was used as an anode, and an AEM (Sustainion® X37-50, RT grade, dioxide materials) separator pretreated with 1.0 M KOH was placed between the cathode and the anode and compressed using stainless steel to manufacture a zero-gap reactor.

### Example 2

A zero-gap reactor of Example 2 was manufactured in the same manner as in Example 1, except that Preparation Example 4 was used instead of using Preparation Example 1 in Example 1.

### Examples 3 to 5

A solution of 500 μg of the nanoclusters of Preparation Examples 1 to 3 dissolved in 160 μL of dichloromethane and 160 μL of acetone were mixed, and ultrasonic dispersion was performed for about 1 minute to prepare a nanocluster composite dispersion. The nanocluster composite dispersion prepared in Preparation Examples 1 to 3 was subjected to solution deposition on a gas diffusion microporous carbon electrode (GDE (W1S1011, Ce-Tech)) with an area of 2.5×2.5 cm² to manufacture a nanocluster composite gas diffusion electrode, and a conventional flow-through electrolytic cell was fabricated using this as a cathode.

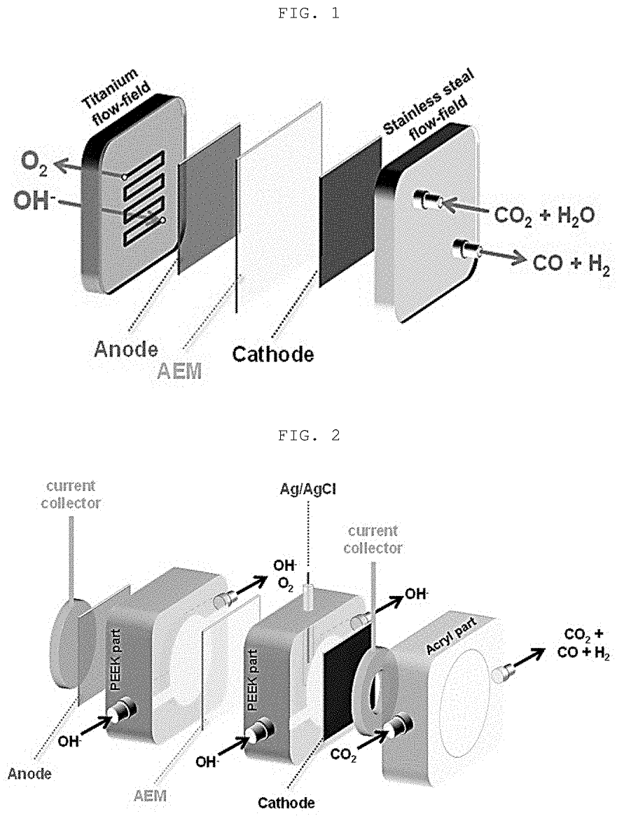

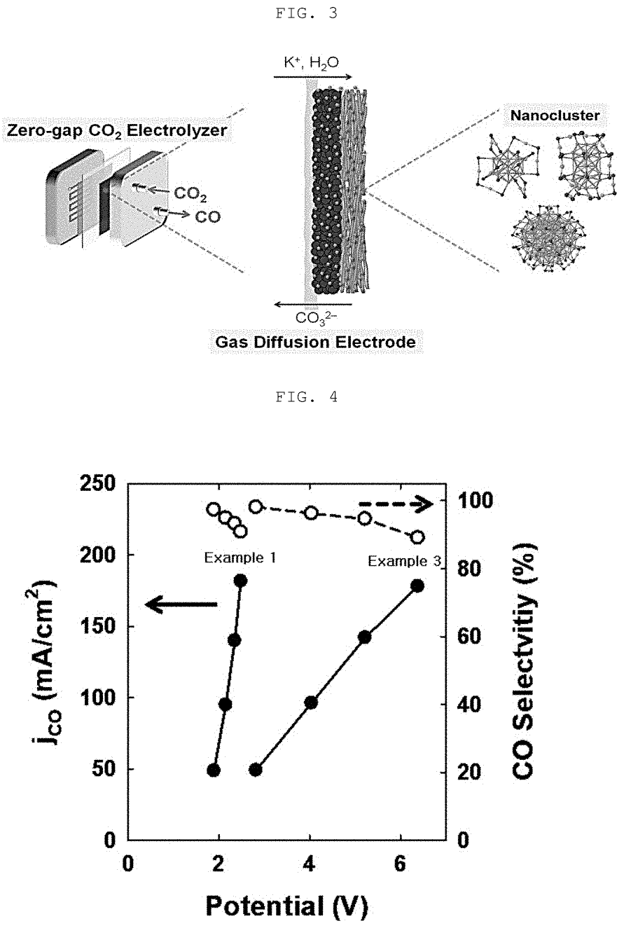

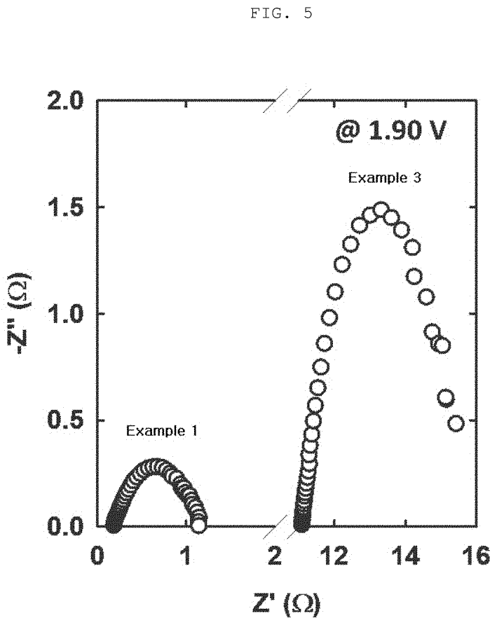

The cathode was fixed to a cathode PEEK part with toroidal stainless steel, and then a Ni foam (NiF, 29-04275-01, Invisible Inc.) anode with an area of 2.5×2.5 cm² was fixed to the anode PEEK part with disc-shaped stainless steel. Here, the reaction area of each electrode is limited to 2 cm² by stainless steel. An AEM (Sustainion® X37-50, RT grade, Dioxide Materials) separator pretreated with 1.0 M KOH in advance was placed between the cathode and anode. As illustrated in the schematic diagram of FIG. 2, the reactor was arranged in the order of a gas flow acrylic part-cathode PEEK part-AEM separator-anode PEEK part and fastened with bolts and nuts to manufacture a flow-through electrolytic cell.

### Comparative Example 1

Comparative Example 1 was performed in the same manner as in Example 3, except that a gas diffusion electrode (Au/C) in which gold nanoparticles having an average particle diameter of 25 nm were supported at 56 μg/cm² on a carbon support was used instead of using Preparation Examples 1 to 3 in Examples 3 to 5.

### Experimental Example 1

Carbon dioxide conversion was performed using the gas diffusion reactors of Examples 3 to 5 and Comparative Example 1.

A 1.0 M KOH solution was circulated at a flow rate of 3 mL/min while nitrogen gas, carbon dioxide gas, and water vapor were supplied to the cathode at 20 sccm. A cold trap was installed at the outlet of the cathode to remove moisture generated from water vapor, and finally, the final product was analyzed by connecting to a gas chromatograph.

It can be seen that FIG. 9 illustrates the result of the conversion rates of carbon dioxide of Examples 3 to 5 and Comparative Example 1 under the conditions of a volume ratio of 0:1, 2:8, 4:6, 7:3, and 1:0 of carbon dioxide gas: nitrogen gas, and Examples 3 to 5 including the metal nanoclusters according to the present invention show significantly improved carbon dioxide conversion rate compared to Comparative Example 1 at all volume ratios. In particular, it can be seen that Examples 3 to 5 exhibit high conversion rates even at low concentrations of carbon dioxide, which means that a carbon dioxide exhaust gas ranging from low concentrations to high concentrations in a process of discharging carbon dioxide may be efficiently converted into carbon monoxide.

Thus, the gas diffusion reactor including the metal nanoclusters according to the present invention may reduce the emission of carbon dioxide into the atmosphere by very efficiently converting carbon monoxide in the exhaust gas of general factories including 12% of carbon dioxide on average, and obtain useful carbon monoxide of high added value, which is industrially very economical and environmentally friendly.

### Experimental Example 2

Carbon dioxide conversion was performed using Examples 1 and 3.

A 1.0 M KOH solution was circulated at a flow rate of 3 mL/min while supplying carbon dioxide gas containing water vapor to the cathode at 200 sccm. A cold trap was installed at the outlet of the cathode to remove moisture generated from water vapor, and finally, the final product was analyzed by connecting to a gas chromatograph.

It can be seen that FIG. 4 illustrates the result of the carbon dioxide conversion rate and the selectivity for the carbon dioxide conversion reaction of Examples 1 and 3, and Example 1 using the zero-gap reactor of the present invention exhibits significantly improved carbon dioxide conversion rate and selectivity for the carbon dioxide conversion reaction compared to Example 3 using the gas diffusion reactor.

It can be seen that FIG. 5 and Table 1 below illustrate the results of measuring the cell resistance of Examples 1 and 3, and Example 1 using the zero-gap reactor of the present invention exhibits remarkably low cell resistance compared to Example 3 using the gas diffusion reactor. Specifically, it can be seen that the cell resistance was reduced by 98% in solution resistance and by 79% in charge-transfer resistance, indicating that the zero-gap reactor of the present invention will exhibit significantly improved low cell resistance and will show better performance in carbon dioxide conversion.

TABLE 1

| | Rₛ (Ω) * | R_{CT} (Ω) ** |
|---|---|---|
| Example 1 | 0.2 | 1.0 |
| Example 3 | 11.2 | 4.8 |

* Rₛ: solution resistance
** R_{CT}: charge-transfer resistance

### Experimental Example 3

In Experimental Example 2, an experiment for carbon dioxide conversion was performed in the same manner as in Experimental Example 2, except that Example 1 was used instead of Examples 1 and 3 and the experiment was conducted for 100 hours. The carbon dioxide inlet and outlet of the cathode were cleaned every 2 hours and completely replaced with 1 L of 1.0 M KOH aqueous solution every 20 hours.

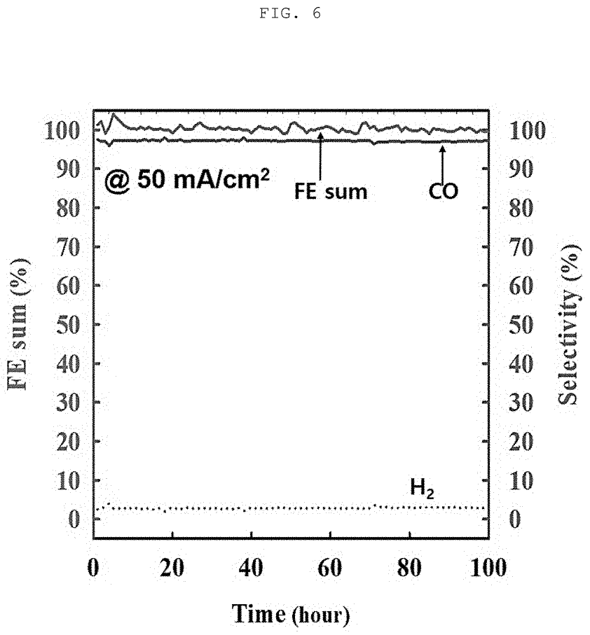

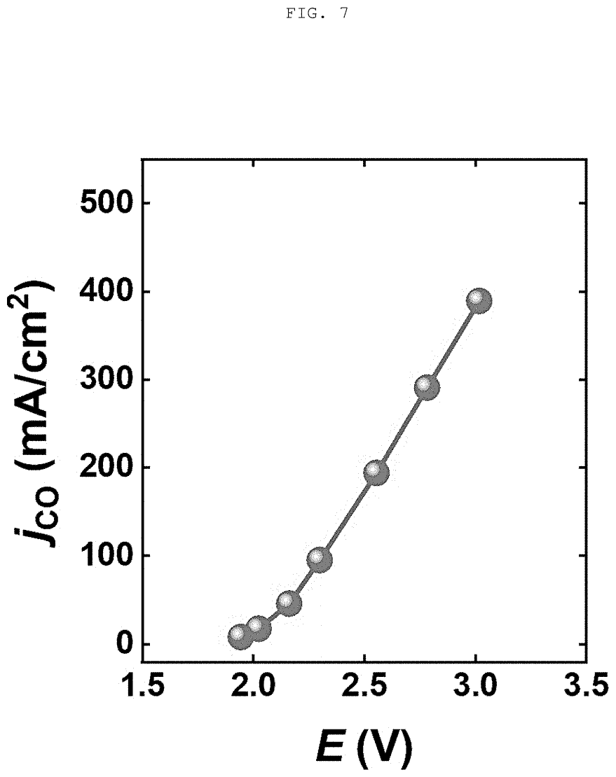

It can be seen that the results are shown in FIG. 6 and the selectivity for the carbon dioxide conversion reaction was stably maintained at 97% or more under the current density condition of 50 mA/cm². Thus, it can be seen that the zero-gap reactor including the metal nanoclusters of the present invention is very stable and exhibits an excellent selectivity for the carbon dioxide conversion reaction even during long-term operation.

### Experimental Example 4

In Experimental Example 2, an experiment for carbon dioxide conversion was performed in the same manner as in Experimental Example 2, except that Example 2 was used instead of Examples 1 and 3.

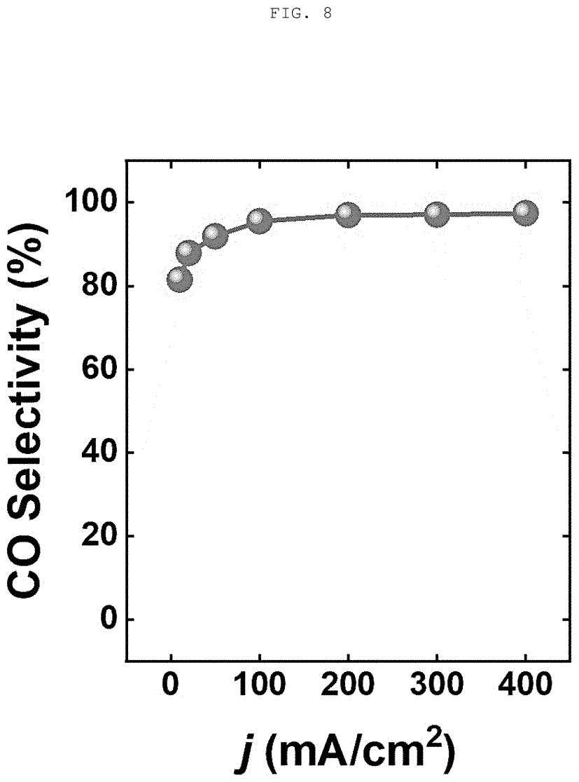

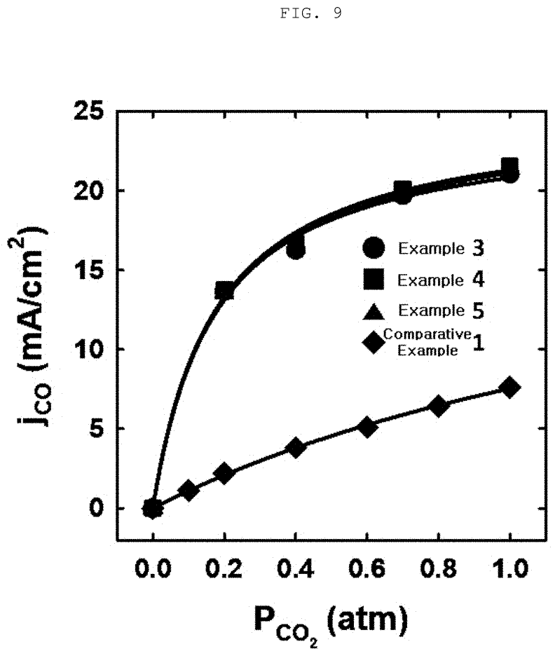

It can be seen that FIGS. 7 and 8 illustrate the result of the carbon dioxide conversion rate and selectivity for the carbon dioxide conversion reaction of Example 2, and Example 2 using a silver nanocluster also shows excellent carbon dioxide conversion rate and selectivity for the carbon dioxide conversion reaction.

### Experimental Example 5

An experiment for carbon dioxide conversion was performed in the same manner as in Experimental Example 1, except that Example 1 using a zero-gap reactor was used instead of Examples 3 to 5 and Comparative Example 1.

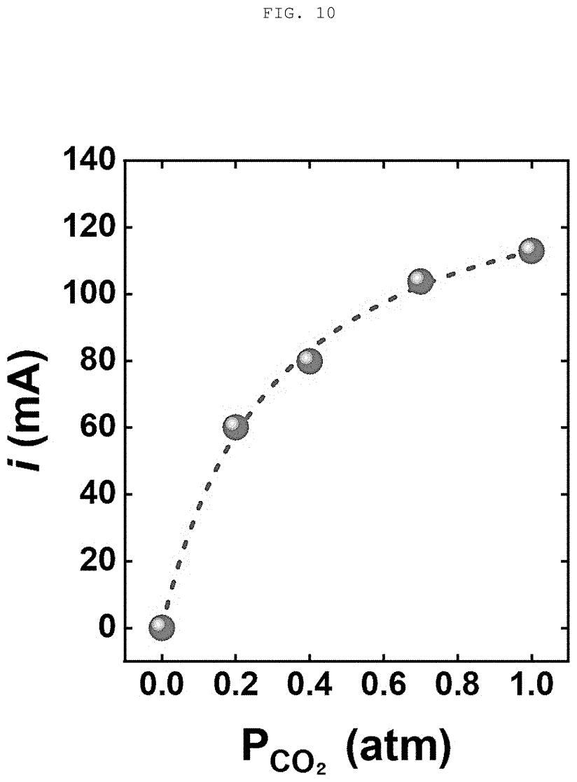

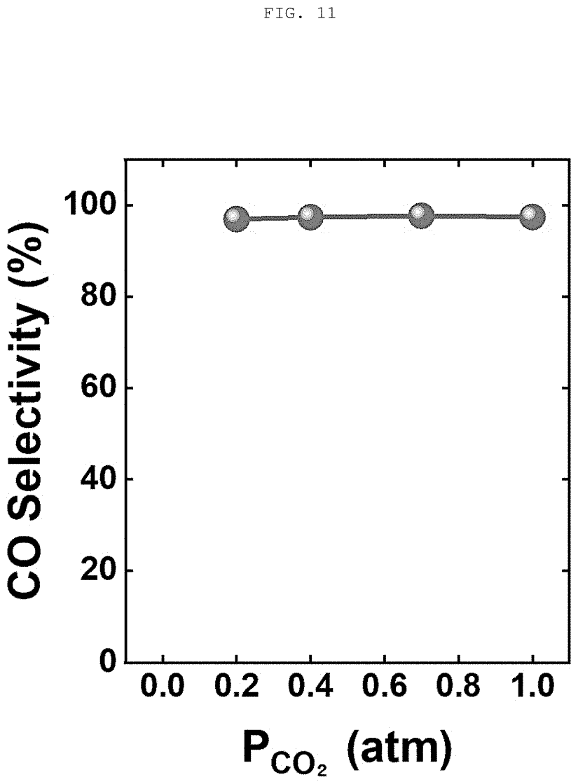

It can be seen that FIGS. 10 and 11 illustrated the results of the conversion rate of carbon dioxide and selectivity for the carbon dioxide conversion reaction of Example 1 under the conditions of the volume ratio of carbon dioxide gas: nitrogen gas of 0: 1, 2: 8, 4: 6, 7: 3, and 1: 0, and Example 1 including the metal nanoclusters according to the present invention exhibits a high carbon dioxide conversion rate of 50 mA or more and excellent selectivity for the carbon dioxide conversion reaction at all volume ratios in which carbon dioxide is present. In particular, it can be seen that Example 1 exhibits high conversion rates even at low concentrations of carbon dioxide, which means that a carbon dioxide exhaust gas ranging from low concentrations to high concentrations in a process of discharging carbon dioxide may be efficiently converted into carbon monoxide.

Thus, the zero-cap reactor including the metal nanoclusters according to the present invention may reduce the emission of carbon dioxide into the atmosphere by very efficiently converting carbon monoxide in the exhaust gas of general factories, including 12% of carbon dioxide on average, and obtain useful carbon monoxide of high added value, which is industrially very economical and environmentally friendly.

As a result, since the zero-gap reactor including the metal nanoclusters according to the present invention exhibits significantly improved conversion rate of carbon dioxide and selectivity for carbon dioxide conversion reaction compared to the conventional flow-through electrolytic cell, and particularly exhibits an excellent carbon dioxide conversion selectivity even at high current densities, it can be industrially used as a high-performance electrochemical carbon dioxide conversion system.

The metal nanoclusters according to the present invention have a structure composed of a specific number of atoms and ligands, and are very useful as catalysts for industrial carbon dioxide conversion because of their excellent activity for a conversion reaction of carbon dioxide.

The gas diffusion electrode including the metal nanoclusters according to the present invention and the zero-gap reactor using the same exhibit excellent performance compared to the conversion of carbon dioxide using a conventional flow-through electrolytic cell, and is a system with significantly improved selectivity for the conversion reaction of carbon dioxide.

Therefore, the gas diffusion electrode for carbon dioxide conversion reaction according to the present invention and the zero-gap reactor including the same may be used to effectively convert carbon dioxide with high selectivity and conversion rate.

Hereinabove, although the present invention has been described by specific matters, the limited embodiments, and Comparative Examples, they have been provided only for assisting in a more general understanding of the present invention. Therefore, the present invention is not limited to the exemplary embodiments. Various modifications and changes may be made by those skilled in the art to which the present invention pertains from this description.

Therefore, the spirit of the present invention should not be limited to the above-mentioned embodiments, but the claims and all of the modifications equal or equivalent to the claims are intended to fall within the scope and spirit of the present invention.

1. A zero-gap reactor for carbon dioxide conversion, comprising: an anode; a cathode including a metal nanocluster catalyst; and a separator positioned between the cathode and the anode.

2. The zero-gap reactor for carbon dioxide conversion of claim 1, wherein the cathode and the anode are positioned in contact with one surface of the separator, respectively.

3. The zero-gap reactor for carbon dioxide conversion of claim 1, wherein the zero-gap reactor for carbon dioxide conversion further includes a cathode support in contact with one surface of the cathode, provided that the one surface of the cathode support further includes a carbon dioxide inlet and a carbon monoxide outlet, and further includes an anode support in contact with one surface of the anode, provided that the anode support further includes a hydroxy group-containing reactant inlet and an oxygen outlet.

4. The zero-gap reactor for carbon dioxide conversion of claim 3, wherein the cathode support or the anode support further includes a flow path connecting each inlet and outlet.

5. The zero-gap reactor for carbon dioxide conversion of claim 1, wherein the cathode is a gas diffusion electrode including metal nanoclusters.

6. The zero-gap reactor for carbon dioxide conversion of claim 5, wherein the gas diffusion electrode includes a porous support and a metal nanocluster catalyst fixed to the pores of the porous support.

7. The zero-gap reactor for carbon dioxide conversion of claim 6, wherein the porous support is a porous carbon body.

8. The zero-gap reactor for carbon dioxide conversion of claim 6, wherein the porous support has an average pore size of 10 to 1000 nm.

9. The zero-gap reactor for carbon dioxide conversion of claim 6, wherein the metal nanocluster catalyst has an average particle size of 1 to 5 nm.

10. The zero-gap reactor for carbon dioxide conversion of claim 6, wherein metal nanocluster catalyst is supported at a density of 1 to 100 nmol/cm² per unit area of the porous support.

11. The zero-gap reactor for carbon dioxide conversion of claim 5, wherein the metal nanocluster catalyst is represented by the following Formula 1
[Formula 1]
Mₙ(SR)ₘ
wherein M is Au or Ag;
SR is C1-C20 alkylthiol, C3-C20 alkenylthiol, C3-C20 alkynylthiol, C6-C20 allylthiol, C3-C20 cycloalkylthiol, C5-C20 heteroallylthiol, C3-C20 heterocycloalkylthiol, or C6-C20 arylC1-C20 alkylthiol;
n is 25, 38, or 144; and
m is 18, 24 or 60.

12. The zero-gap reactor for carbon dioxide conversion of claim 11, wherein SR in Formula 1 is C1-C10 alkylthiol, C3-C10 alkenylthiol, C3-C10 alkynylthiol, C6-C12 allylthiol, C3-C10 cycloalkylthiol, C5-C12 heteroallylthiol, C3-C10 heterocycloalkylthiol, or C6-C10 arylC1-C10 alkylthiol.

13. The zero-gap reactor for carbon dioxide conversion of claim 1, wherein the anode is one or two or more alloys selected from nickel (Ni), iron (Fe), and iridium oxide (IrO₂).

14. The zero-gap reactor for carbon dioxide conversion of claim 1, wherein the separator is an ion exchange membrane.

15. A carbon dioxide conversion method comprising the step of:
supplying a carbon dioxide-containing reaction gas to one surface of a cathode of a zero-gap reactor for carbon dioxide conversion; and
obtaining a carbon monoxide-containing product gas converted from carbon dioxide from one surface of the cathode,
wherein the zero-gap reactor for carbon dioxide conversion is the zero-gap reactor for carbon dioxide conversion of claim 1.

16. The carbon dioxide conversion method of claim 15, wherein the reaction gas further includes one or more selected from nitrogen, oxygen, moisture, NOₓ, SOₓ, and particulate matter.

17. The carbon dioxide conversion method of claim 15, wherein the reaction gas is an exhaust gas of a process of discharging carbon dioxide.
